(19) United States
(12) Patent Application Publication
(10) Pub. No.: US 2014/0253040 A1
(43) Pub. Date: Sep. 11, 2014

(54) PREVENTIVE BALANCING TECHNIQUE FOR BATTERY PACKS IN PORTABLE ELECTRONIC DEVICES

(71) Applicant: APPLE INC., Cupertino, CA (US)

(72) Inventors: Steven C. Michalske, Sunnyvale, CA (US); P. Jeffrey Ungar, Sunnyvale, CA (US)

(73) Assignee: Apple Inc., Cupertino, CA (US)

(21) Appl. No.: 13/872,918

(22) Filed: Apr. 29, 2013

Related U.S. Application Data
(60) Provisional application No. 61/773,975, filed on Mar. 7, 2013.

(51) Int. Cl. H02J 7/00

(52) U.S. Cl. CPC H02J 7/0014
USPC 320/126; 320/134

(57) ABSTRACT

The disclosed embodiments provide a system that manages use of a battery pack in a portable electronic device. During operation, the system detects a characteristic of a battery bank in the battery pack that is associated with a gradual imbalance in the battery pack. Next, the system manages use of the battery pack based on the characteristic to prevent the gradual imbalance in the battery pack.

### RELATED APPLICATION

This application claims the benefit of U.S. Provisional Application No. 61/773,975, Attorney Docket Number APL-P16014USP1, entitled “Preventive Balancing Technique for Batteries in Portable Electronic Devices,” by inventors Steven C. Michalske and P. Jeffrey Ungar, filed 7 Mar. 2013.

### BACKGROUND

1. Field

The disclosed embodiments relate to battery packs for portable electronic devices. More specifically, the disclosed embodiments relate to techniques for preventive balancing of battery packs in portable electronic devices.

2. Related Art

Portable electronic devices, such as laptop computers, portable media players, and/or mobile phones, typically operate using a rechargeable battery. Furthermore, designs for such batteries often include battery packs that contain battery cells connected together in various series and parallel configurations. For example, a six-cell battery pack of lithium-polymer cells may be configured in a three in series, two in parallel (3s2p) configuration. Hence, if a single cell can provide a maximum of 3 amps with a voltage ranging from 2.7 volts to 4.2 volts, then the entire battery pack can have a voltage range of 8.1 volts to 12.6 volts and provide 6 amps of current. The charge in such batteries is typically managed by a circuit, which is commonly known as a protection circuit module (PCM) and/or battery management unit (BMU).

Modern battery pack architectures are also beginning to incorporate asymmetric battery banks containing battery cells of different capacities connected in parallel configurations. For example, a 3s2p battery pack may have three battery banks connected in series and two battery cells connected in parallel within each bank. Two of the battery banks may each include a first battery cell with a capacity of 1.5 Ah and a second battery cell with a capacity of 0.5 Ah, while the third battery bank may include two battery cells, each with a capacity of 1 Ah. The capacities of the cells in each battery bank may add up to the same overall capacity for all three banks, thus enabling matching of states-of-charge among the battery banks during charging and discharging of the battery pack.

However, asymmetric battery pack architectures may include batteries that behave differently than batteries in symmetric battery pack architectures. In particular, symmetric battery pack architectures generally utilize substantially identical battery cells that are manufactured in the same production lot and thus share characteristics such as capacity, self-discharge rates, charge retention features, and/or discharge curves. On the other hand, asymmetric battery pack architectures contain battery cells of different sizes and/or capacities, which may result in different charge and/or discharge profiles for the battery cells. Asymmetry in a battery pack may also be caused and/or exacerbated by differences between the aging characteristics of the battery cells in the battery pack, uneven temperature distribution among the battery cells, and/or other factors that cause the battery cells to behave differently during charging and/or discharging of the battery pack.

Consequently, asymmetric battery packs may be more susceptible to imbalance than symmetric battery packs, particularly after the battery cells are charged and discharged a number of times. For example, a battery bank in an asymmetric battery pack may discharge at a faster rate than other battery banks in the asymmetric battery pack. If all battery banks in the asymmetric battery pack are charged the same amount, the battery bank may reach a lower state-of-charge than the other battery banks during discharge of the battery pack and stay at the relatively lower state-of-charge after the battery pack is charged. The reduction in state-of-charge may also increase with each charge-discharge cycle, resulting in a reduction in the battery bank's capacity to 8-15% less than the capacities of the other battery banks.

Moreover, subsequent balancing of asymmetric battery packs may only temporarily correct for imbalances among the battery banks of the battery packs. Continuing with the above example, the battery pack may be balanced after the battery bank's capacity is 10% lower than the other battery banks' capacities. After the balancing, the battery may continue discharging at a faster rate until the decrease in the battery bank's capacity relative to the other battery banks triggers another balancing of the battery pack, causing the battery bank's capacity to oscillate between 1% and 10% less capacity than the other battery banks.

As a result, conventional balancing techniques may result in suboptimal use of asymmetric battery packs. For example, the oscillation of an asymmetric battery pack between a balanced state and a significant imbalance that triggers a return to the balanced state may reduce the runtime of the battery pack whenever the battery pack is not in the balanced state and prevent the full chemical capacity of the battery pack from being utilized at all times.

Hence, use of battery packs may be facilitated by techniques for actively managing asymmetry and/or imbalance in the battery packs.

### SUMMARY

The disclosed embodiments provide a system that manages use of a battery pack in a portable electronic device. During operation, the system detects a characteristic of a battery bank in the battery pack that is associated with a gradual imbalance in the battery pack. Next, the system manages use of the battery pack based on the characteristic to prevent the gradual imbalance in the battery pack.

In some embodiments, detecting the characteristic of the battery bank that is associated with the gradual imbalance in the battery pack involves obtaining historic imbalance rates for the battery pack, and identifying the characteristic based on the historic imbalance rates.

In some embodiments, the historic imbalance rates are associated with at least one of a voltage threshold and a capacity threshold.

In some embodiments, identifying the characteristic based on the historic imbalance rates involves determining a value of the characteristic based on the historic imbalance rates.

In some embodiments, the characteristic is a higher leakage rate of the battery bank than other battery banks in the battery pack.

In some embodiments, managing use of the battery pack based on the characteristic to prevent the gradual imbalance involves at least one of increasing charge to the battery bank and/or the other battery banks and removing charge from the battery bank and/or the other battery banks.

In some embodiments, the gradual imbalance corresponds to a lower state-of-charge for the battery bank than the other battery banks.

In some embodiments, the battery bank includes a set of battery cells with different capacities connected in a parallel configuration.

### BRIEF DESCRIPTION OF THE FIGURES

FIG. 1 shows a battery pack in accordance with the disclosed embodiments.

FIG. 2 shows a schematic of a system in accordance with the disclosed embodiments.

FIG. 3A shows an exemplary plot in accordance with the disclosed embodiments.

FIG. 3B shows an exemplary plot in accordance with the disclosed embodiments.

FIG. 4 shows a flowchart illustrating the process of managing use of a battery pack in a portable electronic device in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

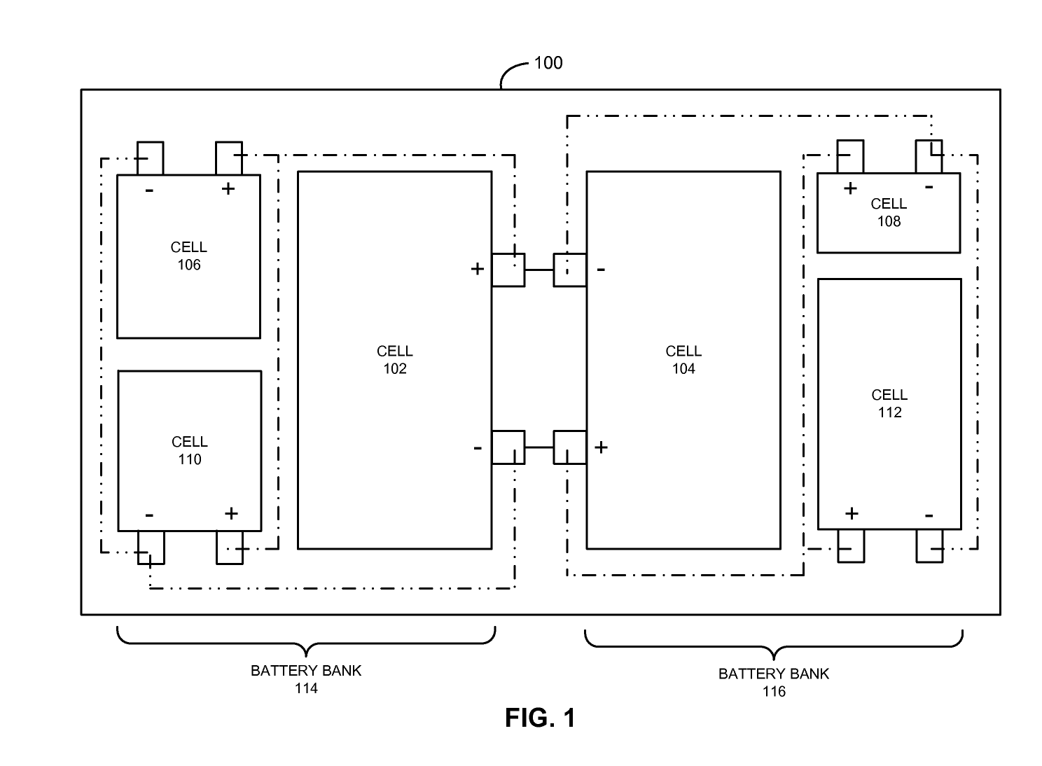

FIG. 1 shows a battery pack 100 in accordance with an embodiment. Battery pack 100 may supply power to a portable electronic device such as a laptop computer, mobile phone, tablet computer, personal digital assistant (PDA), portable media player, digital camera, and/or other type of battery-powered electronic device.

As shown in FIG. 1, battery pack 100 includes a number of cells 102-112. Cells 102-112 may correspond to rechargeable (e.g., secondary) cells such as nickel-cadmium (Ni—Cd) cells, nickel-metal-hydride (Ni-MH) cells, lithium-ion cells, and/or lithium-polymer cells. For example, one or more cells 102-112 of battery pack 100 may be lithium-polymer cells, each of which includes a jelly roll of layers wound together (e.g., a cathode with an active coating, a separator, and an anode with an active coating), and a flexible pouch enclosing the jelly roll.

In one or more embodiments, cells 102-112 have different capacities, thicknesses, and/or dimensions. For example, cells 102-104 may each have a capacity of 3.2 Ah, cells 106 and 110 may each have a capacity of 1.6 Ah, cell 108 may have a capacity of 0.8 Ah, and cell 112 may have a capacity of 2.4 Ah. Similarly, cells 102-104 may be longer, thicker, and/or wider than cells 106-112, cell 112 may be longer, thicker, and/or wider than cells 106-110, and cells 106 and 110 may be longer, thicker, and/or wider than cell 108.

Cells 102-112 may also be electrically coupled in a series and/or parallel configuration. In particular, a first set of cells 102, 106, and 110 with different capacities may be electrically coupled in a parallel configuration to form a first battery bank 114, and a second set of cells 104, 108, and 112 with different capacities may also be electrically coupled in a parallel configuration to form a second battery bank 116. Because the two battery banks 114-116 have substantially the same overall capacity, battery banks 114-116 may be electrically coupled in a series configuration. In other words, cells 102-112 may be electrically coupled in a two in series, three in parallel (2s3p) configuration.

In addition, the selection, electrical configuration, and/or arrangement of cells 102-112 may be based on the physical and/or electrical requirements of the portable electronic device. First, cells 102-112 may be selected for use in battery pack 100 and/or electrically coupled within battery pack 100 to meet the electrical (e.g., voltage, capacity, etc.) demands of components (e.g., printed circuit boards (PCBs), processors, memory, storage, display, optical drives, etc.) in the portable electronic device. For example, cells 102-112 may alternatively be arranged in a 3s2p configuration by electrically coupling cell 106 in parallel to cell 110 and electrically coupling cell 108 in parallel to cell 112 to give the electrically coupled cells 106 and 110 and cells 108 and 112 the same capacity as cell 102 and cell 104 (e.g., 3.2 Ah). Cell 102, cell 104, cells 106 and 110, and cells 108 and 112 may then be electrically coupled in series to increase the voltage of battery pack 100.

Along the same lines, cells 102-112 may be selected for use in battery pack 100 and/or arranged within battery pack 100 to facilitate efficient use of space in the portable electronic device. For example, cells 102-112 may be selected for use in battery pack 100 and stacked, placed side-by-side, and/or placed top-to-bottom within battery pack 110 to accommodate components in a mobile phone, laptop computer, and/or tablet computer. Battery pack 100 may thus include an asymmetric design that maximizes the use of free space within the portable electronic device. In turn, battery pack 100 may provide greater capacity, packaging efficiency, and/or voltage than battery packs containing cells with the same capacity, dimensions, and/or thickness.

However, the asymmetric design of battery pack 100 may cause cells 102-112 to exhibit different charging and/or discharging characteristics during use of battery pack 100 with the portable electronic device. More specifically, different manufacturing processes may be used to produce cells 102-112 of different sizes and/or capacities in battery pack 100. As a result, cells 102-112 may have slightly different behavioral characteristics, including self-discharge rates, charge retention features, and/or discharge curves. While parallel connections among cells 102, 106 and 110 and cells 104, 108 and 112 may accommodate such differences by holding the cells at the same voltage and allowing charge to move among the cells, the connecting of battery banks 114-116 in series may not provide the same self-balancing between battery banks 114-116.

Battery banks 114-116 may thus reach a state of imbalance faster and/or more easily than a symmetrically designed battery pack containing substantially identical cells of the same capacity and size from the same production lot. For example, cells 106 and 110 may discharge faster than cells 108 and 112, causing battery bank 114 to reach a lower state-of-charge and/or capacity than battery bank 116 over a series of charge-discharge cycles. Symmetrically designed battery packs may also be susceptible to gradual and/or accelerated imbalance if the cells within the battery packs are exposed to a temperature gradient and/or other environmental asymmetry that cause the cells to charge, discharge, and/or self-discharge at different rates.

Those skilled in the art will appreciate that conventional balancing techniques for battery packs may not account for differences among cells and/or battery banks in asymmetric battery packs such as battery pack 100. Instead, the balancing techniques may detect large enough imbalances in the battery packs to trigger a balancing of the cells and/or battery banks within the battery packs. Consequently, the balancing techniques may cause the battery packs to fluctuate between states of relative balance and states of significant imbalance that adversely affect use of the battery packs.

For example, battery bank 114 may have a higher self-discharge and/or leakage rate than battery bank 116. As a result, the capacity of battery bank 114 may gradually decrease relative to the capacity of battery bank 116 until the differences in capacity are detected by a balancer, which balances battery banks 114-116 by increasing charge to battery bank 114 and/or decreasing charge to battery bank 116 during a charge-discharge cycle of battery pack 100. The balancer may then resume charging and/or discharging of battery banks 114-116 by the same amount, causing battery bank 114 to continue declining in capacity until differences in the capacities of battery banks 114-116 are detected again by the balancer. In other words, the balancer may cause the capacity of battery bank 114 to oscillate between roughly the same capacity as battery bank 116 and a capacity that is substantially (e.g., 10-15%) lower than the capacity of battery bank 116.

Because such oscillation may prevent full use of the chemical capacity of battery bank 114 by the portable electronic device, the portable electronic device may experience a lower runtime with battery pack 100 than with a comparable battery pack that remains in balance for longer periods. In addition, balancing of battery pack 100 from a significantly imbalanced state may require extensive balancing time and/or deep discharging of battery banks 114-116, which may be difficult and/or unavailable if a user operates battery pack 100 using short, frequent charge cycles.

In one or more embodiments, use of battery pack 100 and/or other asymmetric battery packs is facilitated by detecting characteristics of battery banks (e.g., battery banks 114-116) in the battery packs that are associated with gradual imbalances in the battery packs and managing use of the battery packs based on the characteristics to prevent the gradual imbalances. In other words, preventive balancing of the battery packs may be performed to keep the battery packs from reaching significantly imbalanced states, as discussed in further detail below.

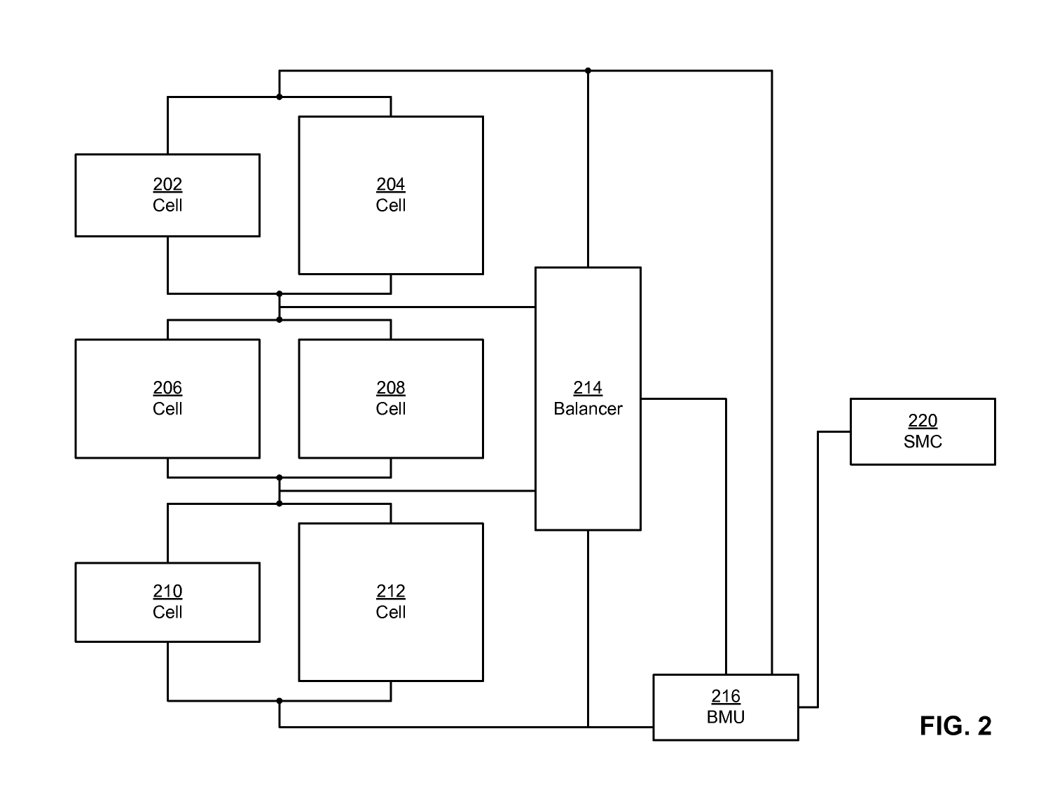

FIG. 2 shows a schematic of a system in accordance with an embodiment. As shown in FIG. 2, the system may include a balancer 214, a BMU 216, and a system microcontroller (SMC) 220.

In one or more embodiments, the system of FIG. 2 provides a power source to a portable electronic device, such as a mobile phone, personal digital assistant (PDA), laptop computer, tablet computer, portable media player, and/or peripheral device. In other words, the system may supply power from a battery pack (e.g., battery pack 100 of FIG. 1) to a load from one or more components (e.g., processors, peripheral devices, backlights, etc.) within the portable electronic device. In addition, the battery pack may include one or more cells 202-212 connected in a series and/or parallel configuration with one another using main power bus 216.

Each cell 202-212 may include a sense resistor (not shown) that measures the cell's current. Furthermore, the voltage and temperature of each cell 202-212 may be measured with a thermistor (not shown), which may further allow a battery “gas gauge” mechanism to determine the cell's state-of-charge, impedance, capacity, charging voltage, and/or remaining charge. Measurements of voltage, current, temperature, and/or other parameters associated with each cell 202-212 may be collected by a corresponding monitor. Alternatively, one monitoring apparatus may be used to collect sensor data from multiple cells 202-212 in the battery.

Data collected by the monitors may then be used by BMU 216 and/or SMC 220 to assess the state-of-charge, capacity, and/or health of cells 202-212. BMU 216 and SMC 220 may be implemented by one or more components (e.g., processors, circuits, software modules, etc.) of the portable electronic device.

In particular, BMU 216 and/or SMC 220 may use the data and/or balancer 214 to manage use of the battery pack in the portable electronic device. For example, BMU 216 and/or SMC 220 may provide a management apparatus that uses the state-of-charge of each cell 202-212 and balancer 214 to adjust the charging and/or discharging of the cell by connecting or disconnecting the cell to a charger. Fully discharged cells may be disconnected from the load during discharging of the battery pack to enable cells with additional charge to continue to supply power to the load. Along the same lines, fully charged cells may be disconnected from the charger during charging of the battery pack to allow other cells to continue charging.

As mentioned above, the system of FIG. 2 may facilitate use of an asymmetric battery pack by preventing gradual imbalances caused by differences in the characteristics of cells 202-212 in the battery pack and/or battery banks containing one or more cells 202-212 of the battery pack. During use of the battery pack with the portable electronic device, BMU 216 and/or SMC 220 may detect a characteristic of a battery bank (e.g., battery banks 114-116 of FIG. 1) in the battery pack that is associated with a gradual imbalance in the battery pack.

In particular, BMU 216 and/or SMC 220 may obtain historic imbalance rates for the battery pack from the monitors and/or other components of the system and identify the characteristic from the historic imbalance rates. For example, BMU 216 and/or SMC 220 may obtain a list of occurrences in which the battery bank caused an imbalance in the battery pack by having a voltage and/or capacity that differed from the voltages and/or capacities of other battery banks in the battery pack by more than a voltage threshold and/or a capacity threshold. The imbalances may be detected using open circuit voltage measurements, a Coulomb-counting technique, and/or another technique for determining the states-of-charge and/or capacities of the battery banks.

During identification of the characteristic, BMU 216 and/or SMC 220 may determine a value of the characteristic based on the historic imbalance rates. For example, BMU 216 and/or SMC 220 may then use voltages and/or capacities for the battery banks from the historic imbalance rates to calculate the amount per charge-discharge cycle by which the battery bank deviated from the other battery banks.

After the characteristic is identified, BMU 216 and/or SMC 220 may manage use of the battery pack based on the characteristic to prevent the gradual imbalance from occurring and/or recurring. For example, BMU 216 and/or SMC 220 may use balancer 214 to adjust the distribution of charge across the battery banks during charging and/or discharging of the battery pack to compensate for the characteristic, thus preventing the battery bank from deviating from the other battery banks and causing an imbalance in the battery pack. In addition, BMU 216 and/or SMC 220 may make such adjustments after an imbalance is initially detected, or BMU 216 and/or SMC 220 may continually manage the charging and/or discharging of cells 202-212 in a way that averts a significant imbalance in the battery pack.

BMU 216 and/or SMC 220 may additionally account for changes in the chemistry and/or behavior of the battery banks over time by detecting new characteristics associated with other types of imbalance in the battery pack and managing use of the battery pack according to the new characteristics. For example, BMU 216 and/or SMC 220 may periodically analyze the historic imbalance rates to identify new characteristics in the battery banks that may lead to imbalances in the battery pack. BMU 216 and/or SMC 220 may then use balancer 214 to proactively update the charging and/or discharging of the battery banks to prevent the imbalances from occurring.

Consequently, the system of FIG. 2 may provide better management and use of the battery pack than a conventional balancer that initiates balancing of the battery pack only after significant imbalances are detected in the battery pack. More specifically, the system of FIG. 2 may perform corrective actions that prevent the significant imbalances from occurring, thus enabling greater use of the battery pack's capacity over time than the conventional balancer. In addition, the continuous balancing performed by balancer 214, BMU 216, and/or SMC 220 may be less disruptive, complicated, and/or difficult than the balancing required to recover the battery pack from a significantly imbalanced state.

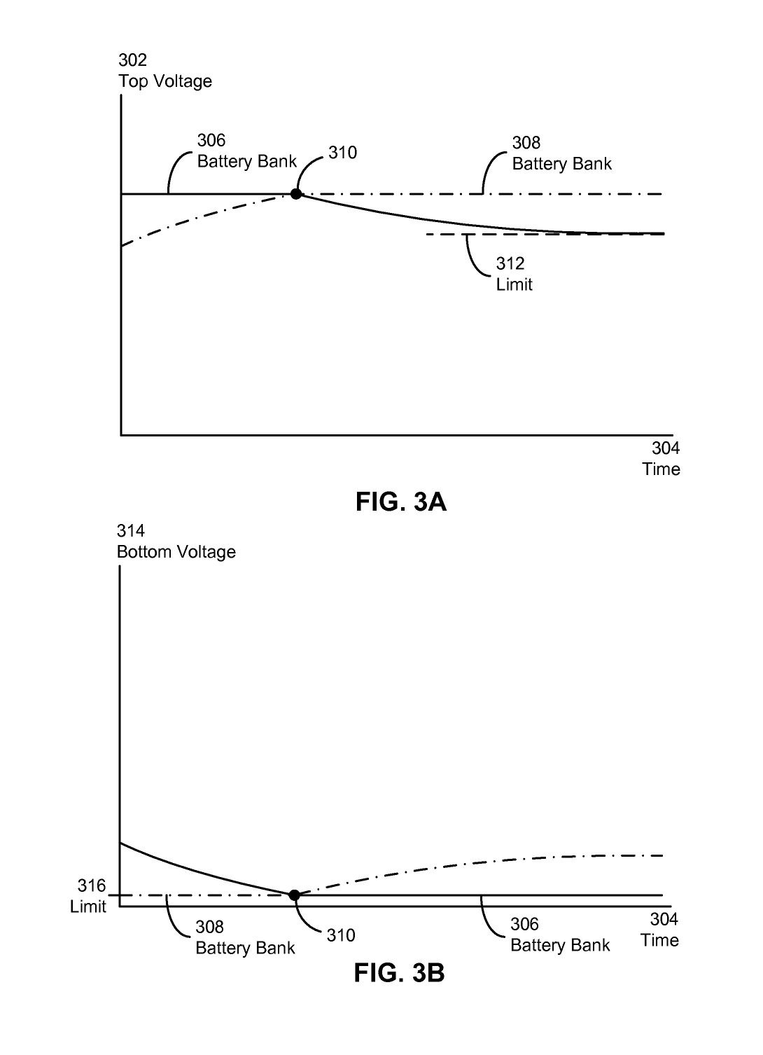

FIG. 3A shows an exemplary plot in accordance with the disclosed embodiments. More specifically, FIG. 3A shows a plot of top voltage 302 over time 304 for a battery pack containing a first battery bank 306 with a higher leakage rate and a second battery bank 308 with a lower leakage rate. Initially, battery bank 306 may have a higher top voltage 302 than battery bank 308. As a result, battery bank 306 may limit the states-of-charge of both battery banks 306-308 by reaching a fully charged state before battery bank 306 and causing both battery banks 306-308 to stop charging.

However, the higher leakage rate of battery bank 306 may cause top voltage 302 to increase slightly for each charge-discharge cycle of battery bank 308. At a point 310 in time 304, top voltage 302 for battery bank 306 may drop below that of battery bank 308, causing the state-of-charge of battery bank 308 to limit the charging of both battery banks 306-308. In turn, battery bank 308 may terminate charging of battery bank 306 at a lower level with each charge-discharge cycle after point 310, causing accelerated reduction in top voltage 302 of battery bank 306. Finally, the reduction in top voltage 302 of battery bank 306 may taper off at a limit 312 at which the leakage rates of battery banks 306-308 equal. In other words, the higher leakage rate of battery bank 306 may be a characteristic of battery bank 306 that causes a gradual imbalance corresponding to a significantly lower state-of-charge for battery bank 306 than battery bank 308 and/or other battery banks in the battery pack.

FIG. 3B shows an exemplary plot in accordance with the disclosed embodiments. More specifically, FIG. 3B shows a plot of bottom voltage 314 over time 304 for battery banks 306-308. Before point 310, the higher top voltage 302 of battery bank 306 may cause bottom voltage 314 to reach a limit 316 that terminates discharging of the battery pack before both battery banks 306-308 are fully discharged.

Over time 304, bottom voltage 314 of battery bank 306 may fall as battery bank 306 experiences a higher leakage rate than battery bank 308. At point 310, bottom voltage 314 of battery bank 306 may also reach limit 316, causing battery bank 306 to subsequently limit the discharging of both battery banks 306-308. Continued leakage of battery bank 306 after point 310 may cause battery bank 308 to stop discharging at a higher level over time 304. Finally, the increase in bottom voltage 314 for battery bank 308 may taper off after the leakage rate of battery banks 306-308 equal.

To prevent such an imbalance from occurring, battery banks 306-308 may be charged and/or discharged so that battery bank 306 continues to limit the charging of both battery banks 306-308. For example, charge to battery bank 306 may be increased and/or charge to battery bank 308 may be decreased to maintain the capacities of battery banks 306-308 seen before point 310. As a result, battery bank 306 may be kept slightly above balance with respect to state-of-charge so that battery banks 306-308 stay in relative balance without explicit balancing of the battery pack. Because capacity 302 is kept close to 100% for both battery banks 306-308, the battery pack may be easier to manage and/or have a longer runtime than a battery pack that is not balanced until limit 312 is reached by a battery bank in the battery pack.

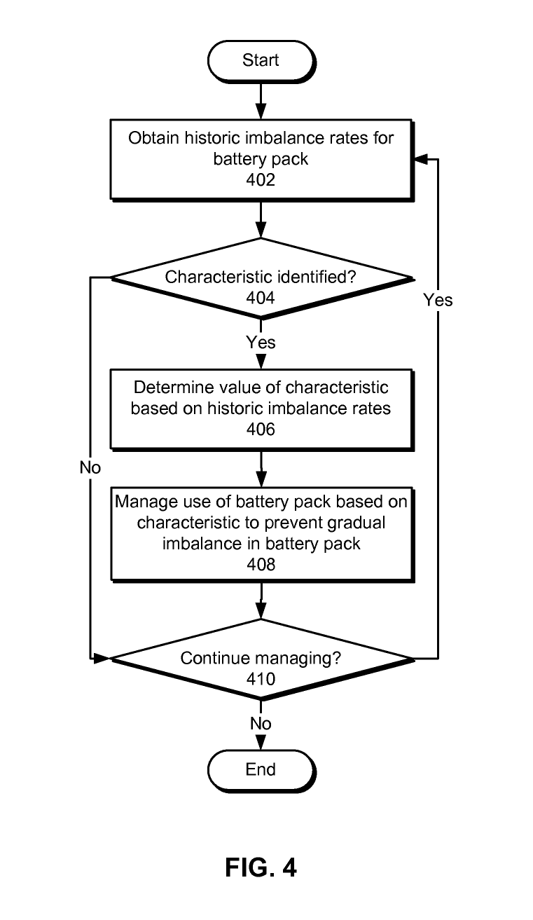

FIG. 4 shows a flowchart illustrating the process of managing use of a battery pack in a portable electronic device in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

As described above, the battery pack may be an asymmetric battery pack. For example, the battery pack may include a set of battery banks connected in a series configuration, with each battery bank containing a set of battery cells with different capacities connected in a parallel configuration. Alternatively, a battery pack with substantially identical battery cells may become asymmetric if the cells age differently and/or are exposed to different temperatures.

First, a characteristic of a battery bank in the battery pack that is associated with a gradual imbalance in the battery pack is detected. To detect the characteristic, historic imbalance rates for the battery pack are obtained (operation 402), and the characteristic may be identified (operation 404) based on the historic imbalance rates. For example, the characteristic may be identified based on the battery bank's deviation from other battery banks in the battery pack by more than a voltage and/or capacity threshold.

If the characteristic is not identified from the historic imbalance rates, no modifications may be made to the charging and/or discharging of the battery pack. If the characteristic is identified, a value of the characteristic is determined based on the historic imbalance rates (operation 406), and use of the battery pack is managed based on the characteristic to prevent the gradual imbalance in the battery pack (operation 408). For example, the characteristic may be detected as a higher leakage rate of the battery bank than the other battery banks. In addition, the higher leakage rate may be determined to cause a reduction in the battery bank's capacity to 10% less than the capacities of the other battery banks after five charge-discharge cycles. As a result, a charge corresponding to 2% of the battery banks' capacities may be added to the battery bank or removed from the other battery banks every charge-discharge cycle to maintain substantially the same capacities across the battery banks.

Management of the battery pack in the portable electronic device may continue (operation 410) during use of the battery pack with the portable electronic device. If the battery is to be managed, characteristics associated with gradual imbalances in the battery pack are identified (operations 402-404), and use of the battery pack is managed based on the characteristics to prevent the gradual imbalances (operations 406-408). For example, three different leakage rates may be identified for three battery banks in the battery pack, causing the three battery banks to be charged to three different levels so that the battery banks discharge to the same level. Changes in the leakage rates over time (e.g., as the battery pack ages) may also be reflected in the levels to which the battery banks are charged to maintain a balanced state in the battery pack. The battery may thus continue to be monitored and managed until the battery is replaced and/or use of the battery is disabled.

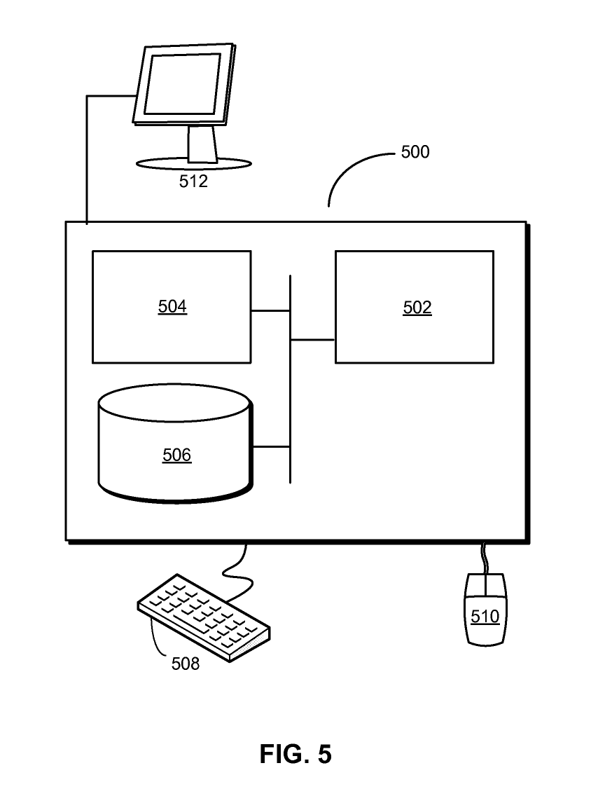

FIG. 5 shows a computer system 500 in accordance with an embodiment. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for managing use of a battery pack in a portable electronic device. The system may include a monitoring apparatus that detects a characteristic of a battery bank in the battery pack that is associated with a gradual imbalance in the battery pack. The system may also include a management apparatus that manages use of the battery pack based on the characteristic to prevent the gradual imbalance in the battery pack. For example, the monitoring apparatus and management apparatus may prevent a lower state-of-charge caused by a higher leakage rate for the battery bank than other battery banks in the battery pack by increasing charge to the battery bank and/or removing charge from the other battery banks during each charge-discharge cycle of the battery pack.

In addition, one or more components of computer system 500 may be remotely located and connected to the other components over a network. Portions of the present embodiments (e.g., monitoring apparatus, management apparatus, etc.) may also be located on different nodes of a distributed system that implements the embodiments. For example, the present embodiments may be implemented using a cloud computing system that monitors and manages battery packs in remote portable electronic devices.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for managing use of a battery pack in a portable electronic device, comprising:
detecting a characteristic of a battery bank in the battery pack that is associated with a gradual imbalance in the battery pack; and
managing use of the battery pack based on the characteristic to prevent the gradual imbalance in the battery pack.

2. The computer-implemented method of claim 1, wherein detecting the characteristic of the battery bank that is associated with the gradual imbalance in the battery pack involves:
obtaining historic imbalance rates for the battery pack; and
identifying the characteristic based on the historic imbalance rates.

3. The computer-implemented method of claim 2, wherein the historic imbalance rates are associated with at least one of a voltage threshold and a capacity threshold.

4. The computer-implemented method of claim 2, wherein identifying the characteristic based on the historic imbalance rates involves:
determining a value of the characteristic based on the historic imbalance rates.

5. The computer-implemented method of claim 1, wherein the characteristic is a higher leakage rate of the battery bank than other battery banks in the battery pack.

6. The computer-implemented method of claim 5, wherein managing use of the battery pack based on the characteristic to prevent the gradual imbalance involves at least one of:
increasing charge to the battery bank or the other battery banks; and
removing charge from the battery bank or the other battery bank.

7. The computer-implemented method of claim 5, wherein the gradual imbalance corresponds to a lower state-of-charge for the battery bank than the other battery banks.

8. The computer-implemented method of claim 1, wherein the battery bank comprises a set of battery cells with different capacities connected in a parallel configuration.

9. A system for managing use of a battery in a portable electronic device, comprising:
a monitoring apparatus configured to detect a characteristic of a battery bank in the battery pack that is associated with a gradual imbalance in the battery pack; and
a management apparatus configured to manage use of the battery pack based on the characteristic to prevent the gradual imbalance in the battery pack.

10. The system of claim 9, wherein detecting the characteristic of the battery bank that is associated with the gradual imbalance in the battery pack involves:
obtaining historic imbalance rates for the battery pack; and
identifying the characteristic based on the historic imbalance rates.

11. The system of claim 10, wherein the historic imbalance rates are associated with at least one of a voltage threshold and a capacity threshold.

12. The system of claim 10, wherein identifying the characteristic based on the historic imbalance rates involves:
determining a value of the characteristic based on the historic imbalance rates.

13. The system of claim 9, wherein the characteristic is a higher leakage rate of the battery bank than other battery banks in the battery pack.

14. The system of claim 13, wherein managing use of the battery pack based on the characteristic to prevent the gradual imbalance involves at least one of:
increasing charge to the battery bank or the other battery banks; and
removing charge from the other battery banks or the other battery banks.

15. The system of claim 13, wherein the gradual imbalance corresponds to a lower state-of-charge for the battery bank than the other battery banks.

16. The system of claim 9, wherein the battery bank comprises a set of battery cells connected with different capacities in a parallel configuration.

17. A computer-readable storage medium storing instructions that when executed by a computer cause the computer to perform a method for managing use of a battery pack in a portable electronic device, the method comprising:
detecting a characteristic of a battery bank in the battery pack that is associated with a gradual imbalance in the battery pack; and
managing use of the battery pack based on the characteristic to prevent the gradual imbalance in the battery pack.

18. The computer-readable storage medium of claim 17, wherein detecting the characteristic of the battery bank that is associated with the gradual imbalance in the battery pack involves:
obtaining historic imbalance rates for the battery pack; and
identifying the characteristic based on the historic imbalance rates.

19. The computer-readable storage medium of claim 18, wherein the historic imbalance rates are associated with at least one of a voltage threshold and a capacity threshold.

20. The computer-readable storage medium of claim 18, wherein identifying the characteristic based on the historic imbalance rates involves:
determining a value of the characteristic based on the historic imbalance rates.

21. The computer-readable storage medium of claim 17, wherein the characteristic is a higher leakage rate of the battery bank than other battery banks in the battery pack.

22. The computer-readable storage medium of claim 21, wherein managing use of the battery pack based on the characteristic to prevent the gradual imbalance involves at least one of:
increasing charge to the battery bank or the other battery banks; and
removing charge from the other battery banks or the other battery banks.

23. The computer-readable storage medium of claim 21, wherein the gradual imbalance corresponds to a lower state-of-charge for the battery bank than the other battery banks.

24. The computer-readable storage medium of claim 17, wherein the battery bank comprises a set of battery cells with different capacities connected in a parallel configuration.
